(19) United States
(12) Patent Application Publication
(10) Pub. No.: US 2026/0269471 A1
(43) Pub. Date: Sep. 10, 2026

(54) ANTENNA ASSEMBLY FOR USE IN A COMMUNICATION DEVICE

(71) Applicant: Thomson Licensing, Cesson-Sevigne (FR)

(72) Inventors: Lizhi ZHAO, Beijing (CN); Ke DAI, Beijing (CN)

(21) Appl. No.: 18/871,830

(22) PCT Filed: Jun. 16, 2022
(86) PCT No.: PCT/CN2022/099202

§ 371 Date: Dec. 5, 2024

(51) Int. Cl. H01Q 5/30; H01Q 1/22; H01Q 5/20

(52) U.S. Cl. CPC H01Q 5/30; H01Q 1/22; H01Q 5/20

(57) ABSTRACT

An apparatus and accompanying antenna assembly is described. The apparatus includes a circuit that processes a communication signal received and/or transmitted wirelessly over a network and an antenna assembly. The antenna assembly includes an antenna structure operating in a first frequency range and a second frequency range that is different from the first frequency range. The antenna assembly includes a first and second conductive element each coupled at one end to a first end and second end of a conductive ground element on the antenna structure. The first and second elements each extend outward in a direction perpendicular to the ground element and away from the antenna structure, the second element extending parallel to the first element. The first and second element form a ground plane extension for the antenna structure improving the performance of the antenna assembly in the first frequency range and/or the second frequency range.

### TECHNICAL FIELD

The present disclosure generally relates to an antenna assembly and, more specifically, to an antenna assembly that is included as part of an electronic assembly in an apparatus, such as a communication device.

### BACKGROUND

Any background information described herein is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

Wireless communication networks are present in many communication systems today. Many of the communication devices used in these systems include one or more antennas for interfacing to the network. These communication devices often include, but are not limited to, set-top boxes, gateways, cellular or wireless telephones, televisions, home computers, media content players, and the like. Further, many of these communication devices may include multiple interfaces for different types of networks. As a result, one or more antennas may be present on or in a communication device.

The antennas used in communication devices are often designed to fit inside the structure of the devices and are required to fit into small areas. As the trend to produce smaller communication devices that can operate using more communication networks continues, the need to reduce the number of antennas within the communication device has become more important. As a result, the use of multi-band antennas and the use of antenna assemblies that are physically separated from the interface circuitry for the antenna, has become prevalent. FIG. 1 illustrates an exemplary antenna assembly designed to be located inside a communication device. The antenna assembly in FIG. 1 may be referred to as a dual-band antenna and is designed to receive and transmit frequencies used by a wireless communication network across two different frequency bands. The antenna assembly in FIG. 1 is designed to work on two cellular long term evolution (LTE) frequency bands referred to as band 28, from 700 to 800 megahertz (MHz), and band 7, from 2500 to 2700 MHz. FIG. 1 includes a printed circuit board 105 that is as a base material for supporting a group of conductive traces in a pattern layout. Printed circuit 105 includes conductive traces 110, and 130 that form the active elements for the signal transmission and reception portion of the antenna. Both conductive trace 110 and conductive trace 130 may include dimensional characteristics, different lengths, widths, and shapes including additional bends, directions, and angles, as shown in FIG. 1. The dimensional characteristics may be configured through a design process to enhance the performance of the antenna while being used for signals within the two different frequency ranges. Signal interface connection 120 is connected to conductive traces 110, and 130 and provides an external signal interface for the communication signal between the antenna and any interface circuitry in the communication device. A coaxial cable 190 is connected at one end to signal interface 120. The other end of coaxial cable 190 is used to connect to the other circuitry.

Printed circuit board 105 also includes a group of conductive traces 140, 150 (missing or mislabeled), 160, and 170 that provide a ground reference for the active elements of the antenna described above. The conductive traces 140, 150, 160, and 170 do not connect to conductive traces 110 and 130. As with the conductive traces 110 and 130, conductive traces 140, 150, 160, and 170 may be configured to include dimension characteristics as described above. Ground interface connection 150 is connected to conductive traces 140, 150, 160, and 170 and provides an external ground interface for the communication signal between the antenna and the interface circuitry in the communication device. A coaxial cable 190 is shown attached to the signal interface connection 120 and ground interface connection 150 to provide the electrical connection of the signal between the antenna assembly and the other circuitry.

FIG. 1 also includes a conductive foil sheet 180 that is connected at one end to conductive trace 170. Conductive foil sheet 180 (missing or mislabeled) extends beyond printed circuit board 105 in an outward direction perpendicular to conductive trace 170. The end of foil conductor 180 opposite the end connected to conductive trace 170 is used to connect a ground that is near the ground used for the other circuitry in the communication device and connected to coaxial cable 190. In this manner, conductive foil sheet 180 operates as a ground extension for the antenna assembly in FIG. 1 in relation to the interface circuitry in the communication device. The dimensions of conductive foil sheet 180 may be configured to include dimension characteristics as described above in order to improve the performance of the antenna assembly in frequency band 1 as well as to accommodate the connection to the communication device.

The use of a conductive foil sheet, such as conductive foil sheet 180 in FIG. 1, that is used to provide a ground extension for a stand-alone antenna assembly has some shortcomings. The conductive foil sheet from the antenna assembly is attached and connected to a part of the communication device, such as a printed circuit board that contains the interface circuitry for the antenna at or near the time of final assembly of the communication device. The typical attachment method is either soldering or gluing using a conductive glue. Soldering a conductive foil having a larger edge dimension into the communication device at this point of assembly can cause unintended damage or heat stress to the other components or the printed circuit board near the point of soldering. The use of conductive glue can be expensive and also may prove unreliable as the glue dries out over time due to environmental effects. Additionally, the large attachment region that is required to attach the conductive foil sheet occupies space on the part or component, such as the printed circuit board, which cannot be used for other purposes.

Finally, once assembled in the communication device, removal of the antenna assembly or the conductive foil sheet for any purpose, including repair, replacement, or rework of the antenna assembly or other parts of the communication device in the vicinity of the antenna assembly or conductive foil sheet can be very difficult. The process of moving the antenna assembly may damage or destroy the conductive foil sheet and attempts to detach the conductive foil sheet from the connection to the communication device can result in damaging the conductive foil sheet, the attachment region for the conductive foil sheet, or part of the communication device itself. Therefore, there is a need for an improved antenna assembly that improves manufacturability while maintaining the performance of the antenna

### SUMMARY

These and other drawbacks and disadvantages presented by antenna assemblies for use in communication devices are addressed by the principles of the present disclosure. However, it can be understood by those skilled in the art that the present principles may offer advantages in other types of devices and systems as well.

According to an implementation, an antenna assembly is described. The antenna assembly includes an antenna structure configured to operate in a first frequency range and a second frequency range that is different from the first frequency range. The antenna assembly further includes a first conductive element coupled at one end to a first end of a conductive ground element on the antenna structure, the first conductive element extending outward in a direction perpendicular to the ground element and away from the antenna structure and a second conductive element coupled at one end to a second end of the ground element on the antenna structure, the second conductive element extending outward in a direction perpendicular to the conductive ground element away from the antenna structure, the second conductive element extending parallel to the first conductive element. The first conductive element and the second conductive element form a ground plane extension for the antenna structure that improves the performance of the antenna assembly in at least one of the first frequency range and the second frequency range of operation.

According to an implementation, an apparatus is described. The apparatus includes a circuit capable of at least one of processing a communication signal received wirelessly from a network and processing a communication signal for transmission wirelessly to the network and an antenna assembly coupled to the circuit. The antenna assembly includes an antenna structure configured to operate in a first frequency range and a second frequency range that is different from the first frequency range. The antenna assembly further includes a first conductive element coupled at one end to a first end of a conductive ground element on the antenna structure, the first conductive element extending outward in a direction perpendicular to the ground element and away from the antenna structure and a second conductive element coupled at one end to a second end of the ground element on the antenna structure, the second conductive element extending outward in a direction perpendicular to the conductive ground element away from the antenna structure, the second conductive element extending parallel to the first conductive element. The first conductive element and the second conductive element form a ground plane extension for the antenna structure that improves the performance of the antenna assembly in at least one of the first frequency range and the second frequency range of operation.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a diagram of an exemplary antenna;

FIG. 2 is a block diagram of an exemplary communication device to which the principles of the present disclosure are applicable;

FIG. 3 is a diagram of an exemplary antenna assembly to which the principles of the present disclosure are applicable;

FIG. 4 is a diagram of another exemplary antenna assembly to which the principles of the present disclosure are applicable;

FIG. 5 is a graph illustrating characteristics of an exemplary antenna assembly to which the principles of the present disclosure are applicable;

FIG. 6 is a perspective view of an exemplary electronic assembly having an integrated antenna assembly in a communication device to which the principles of the present disclosure are applicable; and

FIG. 7 is a perspective view of another exemplary electronic assembly having an integrated antenna assembly used in a communication device to which the principles of the present disclosure are applicable.

### DETAILED DESCRIPTION

The present disclosure may be applicable to electronic apparatuses or devices described as being assembled apparatuses or devices having one or more integrated antenna assemblies. The present disclosure further addresses manufacturing and assembly issues associated with the use of one or more of the various available integrated antenna assemblies that may be used in electronic apparatuses or devices.

The present description illustrates the principles of the present disclosure. It will thus be appreciated that those skilled in the art will be able to devise various arrangements which, although not explicitly described or shown herein, embody the principles of the present disclosure and are included within the scope of the claims.

All examples and conditional language recited herein are intended for pedagogical purposes to aid the reader in understanding the principles of the present disclosure and the concepts contributed by the inventor(s) to furthering the art and are to be construed as being without limitation to such specifically recited examples and conditions.

Moreover, all statements herein reciting principles, aspects, and embodiments of the principles of the present disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the embodiments hereof, any element expressed or described, directly or indirectly, as a means for performing a specified function is intended to encompass any way of performing that function including, for example, a) a combination of elements that performs that function or b) any mechanism having a combination of electrical or mechanical elements to perform that function. The disclosure as defined by such claims resides in the fact that the functionalities provided by the various recited means are combined and brought together in the manner which the claims call for. It is thus regarded that any means that can provide those functionalities are equivalent to those shown herein.

The present embodiments address problems associated with antenna assemblies that utilize ground extension elements, such as a conductive foil sheet, to provide an improved ground reference, or grounding interface, between the active elements of an antenna assembly and the interface components or circuits that are physically separated from the antenna assembly. The issues include, but are not limited to, assembly difficulties, long term reliability of the connection to the conductive foil, and difficulty of disassembly for repair, replacement, or rework. Further, the elimination of the ground extension element from the antenna will degrade the performance of the antenna, impeding its ability to transmit and receive wireless signals in the operational frequency ranges or bands for the antenna assembly.

The present disclosure addresses these problems by replacing the conductive foil sheet by one or more conductive traces or elements, such as electrical wires. The electrical wires are connected and positioned in such a manner as to approximate the edge outline of the two unconnected parallel sides of the perimeter shape of the conductive foil sheet. The position, spacing, and any other dimensions of the electrical wires may be adjusted, or tuned, to produce the same or similar performance level for the antenna assembly having the conductive foil sheet, in particular with respect to signal transmit and receive characteristics in the operational frequency ranges or bands for the antenna assembly.

The embodiments take advantage of certain aspects associated with the use of conductive elements or electrical wires instead of a conductive foil sheet. The electrical wires are easier to attach to parts of the electronic apparatus or device, such as a printed circuit board. Additionally, in some cases, the electrical wires may be attached using a plug and socket interface mechanism, making assembly and disassembly even easier. Further, electrical wires are more easily manipulated or adjusted, making positioning or repositioning easier and less prone to causing damage.

Finally, the use of conductive elements or electrical wires that trace the edge outline of the two unconnected sides of the original conductive foil sheet as a replacement for the solid surface of the conductive foil sheet is based, in part, on the principle of skin effect in conductors. Skin effect reduces the effective section of the conductor in which alternative current flows through a conductive material. The depth to which current flows is reduced as the frequency increases. As a result, the current density along the edges of the conductive foil sheet will be higher than within the interior. The electrical wires allow a similar current density to flow without significantly affecting the current density characteristics produced by the conductive foil sheet.

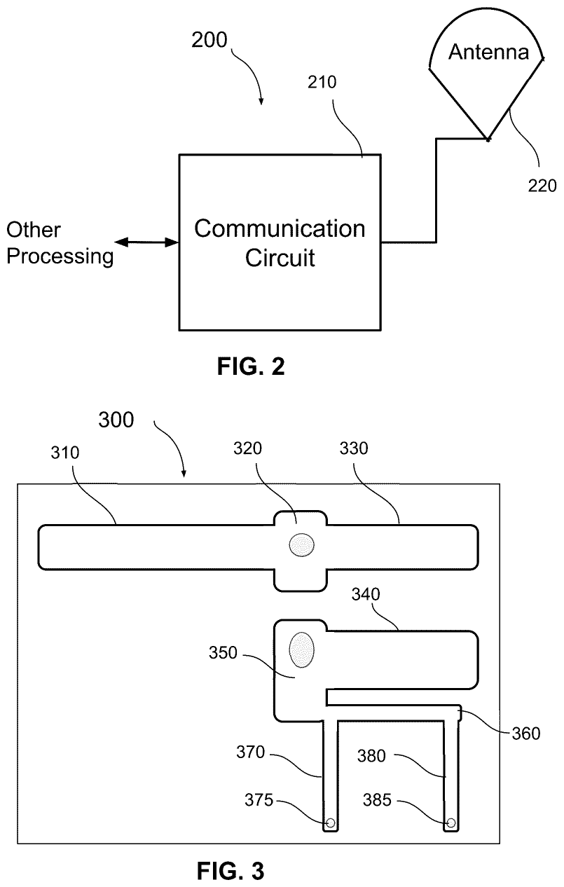

Turning to FIG. 2 a block diagram of an embodiment of a communication device 200 according to aspects of the present disclosure is shown. Communication device 200 may be used as part of a communication receiver, transmitter, and/or transceiver device including, but not limited to, a handheld radio, a set-top box, a gateway, a modem, a router, a cellular or wireless telephone, a cellular or wireless outdoor unit, a television, a home computer, a tablet, and a media content player. Communication device 200 may include one or more interfaces to wireless networks including, but not limited to, third generation (3G), LTE, or fifth generation (5G) cellular, Institute of Electrical and Electronics Engineers (IEEE) standard 802.11, Wi-Fi, or other similar wireless communication protocols. It is important to note that several components and interconnections necessary for complete operation of communication device 200, either as a standalone device or incorporated as part of another device, are not shown in the interest of conciseness, as the components not shown are well known to those skilled in the art.

Communication device 200 includes a communication circuit 210 that interfaces with other processing circuits, such as a processor, memory, and user interface, not shown. Communication circuit 210 connects to antenna 220. Antenna 220 provides the interface to the airwaves for transmission and reception of signals to and from communication device 200.

Communication circuit 210 includes circuitry for performing signal transmission and reception of a signal interfaced through antenna 220 to another device over a wireless network. A received signal from antenna 220 may be processed by a low noise amplifier and tuned by a set of filters, mixers, and oscillators included in communication circuit 210. The tuned signal may be digitized and further demodulated and decoded. The decoded signal may be provided to other processing circuits. Additionally, communication circuit 210 generates, converts, and/or formats an input signal (e.g., an audio, video, or data signal) from the other processing circuits for transmission through antenna 220. Communication circuit 210 may include a power amplifier for increasing the transmitted signal level of the signal sent from communication device 200 over the wireless network. Adjustment of the amplification applied to a signal received from antenna 220 as well as amplification for a signal transmitted by antenna 220 may be controlled by a control circuit in communication circuit 210 or may be controlled by other processing circuits.

Communication circuit 210 also includes interfaces to send and receive data (e.g., audio and/or video signals) to other processing circuits (not shown). Communication circuit 200 further amplifies and processes the data in order to either provide the data to antenna 220 for transmission or to provide the data to the other processing circuits. Communication circuit 210 may receive or send audio, video, and/or data signals, either in an analog or digital signal format. In one embodiment, communication circuit 210 has an ethernet interface for communicating data to other processing circuits and wireless network interface for communicating with antenna 220. Communication circuit 210 includes processing circuits for converting signals between ethernet format and a wireless format (e.g., 3G cellular format).

Antenna 220 interfaces signals between communication circuit 210 and the over-the air wireless network (e.g., a 3G or LTE cellular network). In some embodiments, antenna 220 may be configured for transmitting and receiving wireless signals that are present over a range of frequencies. The range of frequencies may be separated into separate frequency bands, easing the requirements and/or capabilities of design of the antenna. These frequency bands may be separated within the range of frequencies. For instance, LTE cellular wireless devices communicate using band 28, from approximately 700 to 800 MHz, and band 7, from approximately 2500 to 2700 MHz. In one embodiment, antenna 220 may be configured for optimally transmitting and receiving wireless signals that are present in two of the frequency bands used within the range of frequencies for the LTE cellular service while having reduced transmission and reception capability for wireless signals present at frequencies outside those two frequency bands.

Antenna 220 may be physically separated from communication circuit 210 in communication device 200. The separation may be necessary to prevent interference between the operation of antenna 220 and communication circuit 210. The separation may additionally or alternatively be necessary to allow for proper or best positioning for the operation of antenna 220 with respect to area or space within communication device 200. In these instances, antenna 220 may be referred to as an antenna assembly. Antenna 220 may include a connection interface for communicating the transmitted and received signals with communication circuit 210. In some embodiments, the connection interface may utilize a coaxial cable for the signal connection associated with ground reference connection between antenna 220 and the interface at communication circuit 210. Further, an additional ground extension element may be connected between a ground reference point at or on antenna 220 and a ground point at or near the ground reference point for the interface at communication circuit 210.

It is worth noting that more than one antenna 220 may be used in communication device 200. The use of more than one antenna provides additional performance capability and control options. For example, in one embodiment, a first antenna may be oriented in a first orientation or axis with a second antenna oriented in a second orientation or axis. In another embodiment, two antennas may be spaced physically at opposite ends of communication device 200 or a larger apparatus that includes communication device 200.

Communication device 200 in FIG. 2 is described primarily as operating according to a cellular wireless network, such as 3G or LTE. It should be appreciated by one skilled in the art that other network standards and protocols that incorporate a wireless physical interface may be used. For instance, communication device 200 may easily be configured to operate according to standards and protocols for a Bluetooth network, a WiMax network, a Wi-Fi network or any number of wireless network standards or protocols that are, or will be, available. Further, more than one of these networks may be used either alternatively or simultaneously together.

Turning now to FIG. 3, a diagram of an exemplary antenna assembly 300 according to aspects of the present disclosure is shown. Antenna assembly 300 may be included as part of an apparatus used for wireless communications, such as communication device 200 described in FIG. 2. Antenna assembly 300 may be referred to as a dual-band or multi-band antenna for use with one or more ranges of frequencies, or frequency bands, associated with wireless network communications as described above.

Antenna assembly 300 includes a conductive element 310 coupled to a signal interface connection 320 at one end and extending in a first direction away from the signal interface connection 320. The signal interface connection 320 is also coupled to a conductive element 330 that extends outward from the signal interface connection 320 in a direction that is opposite to the direction for conductive element 310. A conductive element 340 is positioned adjacent to and parallel to conductive element 330. A signal interface connection 350 is located adjacent to and parallel to signal interface connection 320 and is coupled to conductive element 340. Signal interface connection 350 is also coupled to conductive element 360 which is positioned adjacent to and parallel to conductive element 340. A conductive element 370 is coupled, at one end, to the end of conductive element 360 nearest to signal interface connection 350. Conductive element 370 extends outward in a direction perpendicular to conductive element 360 and away from conductive element 340. Conductive element 370 includes a signal interface connection 375 at the end farthest from conductive element 360. A conductive element 380 is coupled to the end of conductive element 360 farthest from the signal interface connection 350. Conductive element 380 extends outward in a direction adjacent to and parallel to conductive element 370. Conductive element 380 includes a signal interface connection 385 at the end farthest from conductive element 360.

It is worth noting that elements that are adjacent to each other may generally be considered as having some physical distance between them. The physical distance may be open space or may be occupied, or filled, with some type of material. Preferably, the material does not affect the performance of the elements and the antenna. In general, the elements may not be electrically connected at any points other than a coupling as described. However, in some embodiments, elements may be considered adjacent to each other while having some aspects that are different than as described here. Further, in some embodiments, elements may be adjacent to each other while not strictly parallel to each other. In such embodiments, the term parallel to each other may be interpreted as maintaining some distance between the elements while still taking advantage of one or more aspects of the present disclosure.

The conductive elements described in antenna assembly 300 may be formed using a conductive material including, but not limited to, copper, brass, nickel, aluminum, and the like. Some or all of the elements of antenna assembly 300 may be free standing or self-supporting. In some cases, two or more of the elements, such as signal interface connection 320 and signal interface 350, may be mechanically coupled together using a non-metallic structure, such as a plastic stand-off. Further, some or all of the conductive elements described in antenna assembly 300 may be printed, etched, or laminated onto a non-metallic material, such as a rigid laminate material, such as a printed circuit board, or a flexible plastic or polymer film material.

Signal interface connection 320 provides an interface for the communication signal, referred to as a feed line. Signal interface connections 350, 375, and 385, provide connection to a signal ground with respect to the communication signal. In some embodiments, signal interface connection 320 is connected to the center conductor, or signal conductor, and signal interface connection 350 is connected to the outer shield, or ground conductor, of a coaxial cable used for interfacing the communication signal to or from antenna assembly 300 with the communication circuit (e.g., communication circuit 210 in FIG. 2). The signal interface connections 375 and 385 provide a connection to a signal ground at a location near the communication circuit. The connection mechanism at the signal interface connections 320, 350, 375, and 285 may include a solder connection, or a removable plug interface.

As shown in FIG. 3, conductive element 310, which may be referred to as the first driven antenna element of antenna assembly 300, is configured to operate over a first frequency range. Conductive element 330, which may be referred to as the second driven antenna element of antenna assembly 300, is configured to operate over a second frequency range. The first frequency range and second frequency range may be contiguous, overlapping, or separated. Further, the frequency bandwidth of the first frequency range and the second frequency range may be different. In one embodiment, the first frequency range is 700 to 800 MHZ, covering frequency band 28 and the second frequency range is 2500 to 2700 MHz, covering frequency band 7, as described above. Other antennas using similar aspects of antenna assembly 300 may be constructed to operate over different frequency ranges.

Conductive elements 340, 360, 370, and 380 provide a portion of the ground reference used as part of the operational characteristics of one or both of the first antenna element (i.e., conductive element 310) and second antenna element (i.e., conductive element 330) of antenna assembly 300. These operational characteristics may include, but are not limited to, the center frequency of operation, the operational frequency bandwidth around the center frequency, the input characteristic impedance or input return loss within the operational frequency bandwidth, and the antenna gain or beamwidth. The operational characteristics for the first antenna element and the second antenna element of antenna assembly 300 may be determined or configured by adjusting one or of the physical dimensions of each of the conductive elements 310 and 330, including the length, width, and/or thickness. In one embodiment, conductive element 310 has a length of 2.25 inches and a width of 0.125 inches and conductive element 330 has a length of 0.75 inches and width of 0.125 inches. The operational characteristics may further be modified by adjusting the dimensions of each of the conductive elements 340, 360, 370, and 380, along with the relative positions and distances between adjacent conductive elements as well as distances from conductive elements 310 and/or 330. In some embodiments, the operational characteristics of conductive element 310, which operate over the first frequency range, are modified by adjusting the length of and the distance between conductive elements 370 and 380. In one embodiment, conductive elements 370 and 380 are separated by a distance of 0.6 inches. For most applications, it is expected that conductive elements 370 and 380 will be separated by at least 0.5 inches in order to effectively operate as a ground plane extension. The configuration and operation of multi-band antennas similar to antenna assembly 300 will be described in further detail below.

It is worth noting that, in some embodiments, conductive elements 340 and 360 may be configured without spacing or separation. As such, conductive elements 340 and 360 may be referred to as a single conductive element 360 connected to signal interface connection 350 and conductive elements 370 and 380 as described above.

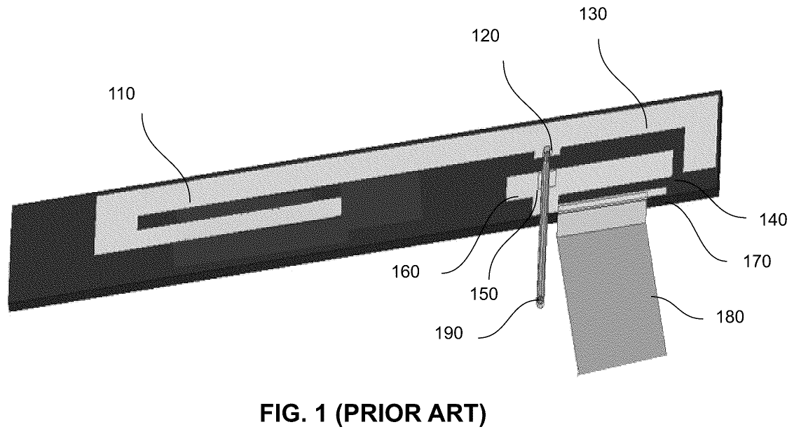

As described above, conductive elements 370 and 380 are positioned in such a manner as to approximate the edge outline of the two unconnected parallel sides of the perimeter shape of a conductive foil sheet. The length of each of conductive elements 370 and 380 and the spacing between them may be similar to the desired length and width, respectively, of a conductive foil sheet (e.g., conductive foil sheet 170 in FIG. 1). The width of each of the conductive elements 370 and 380 is much less than the width of the conductive sheet. The width of each of the conductive elements 370 and 380 may be the same or different and may be determined based on the operating frequencies for the antenna. Further, the length, position, spacing, and width of conductive elements 370 and 380 may be adjusted, or tuned, to produce the same or similar level of performance as the conductive foil sheet. In one embodiment, the length and width of conductive elements 370 and 380 may be 2.25 inches and 0.020 inches respectively.

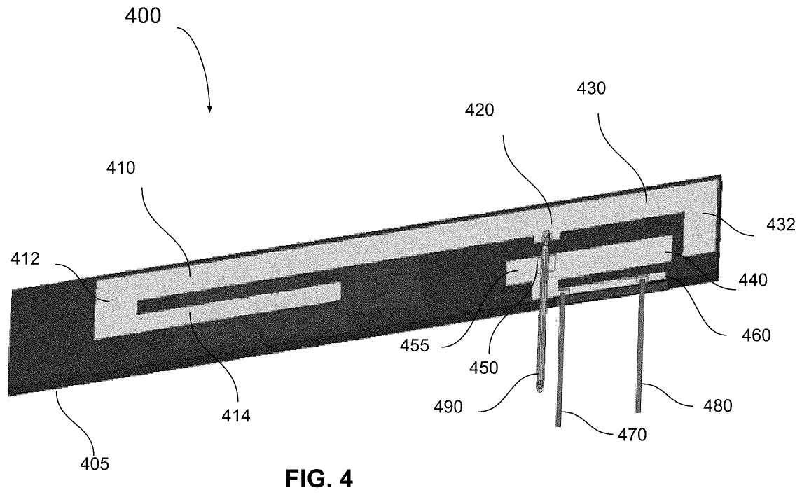

Turning now to FIG. 4, a diagram of another exemplary antenna assembly 400 according to aspects of the present disclosure is shown. antenna assembly 400 may be included as part of an apparatus used for wireless communications, such as communication device 200 described in FIG. 2. Antenna assembly 400 operates over the same two frequency ranges and in a manner similar to antenna assembly 300 described in FIG. 3. Antenna assembly 400 may further be referred to as a type of dual-band or multi-band antenna, and more specifically, a meander-line dual-band or multi-band antenna.

Antenna assembly 400 includes a conductive element 410 coupled to a signal interface connection 420 at one end and extending in a first direction away from the signal interface connection 420. The signal interface connection 420 is also coupled to a conductive element 430 that extends outward from the signal interface connection 420 in a direction that is opposite to the direction for conductive element 410. A conductive element 412 is coupled, at one end, to the end of conductive element 410 farthest from signal interface connection 420 and extends in a direction perpendicular to conductive element 410. A conductive element 414 is coupled to the other end of conductive element 412. Conductive element 414 is positioned adjacent to and parallel to conductive element 410 and extends back towards signal interface connection 420. A conductive element 432 is coupled, at one end, to the end of conductive element 430 farthest from signal interface connection 420 and extends in a direction perpendicular to conductive element 430.

It is worth noting that elements 405, 410, 412, 414, 420, 430, 432, 440, 450, 455, and 460 may collectively be referred to as an antenna structure. It is also worth noting that conductive elements, 410, 412, and 414 may collectively be referred to as the first driven antenna element of antenna assembly 400 as described above. Further, elements 430 and 432 may collectively be referred to as the second driven antenna element as described above.

A conductive element 440 is positioned adjacent to and parallel to conductive element 430 and is coupled, at one end, to signal interface connection 450, which is located adjacent to and parallel to signal interface connection 420. Conductive element 440 extends from signal interface connection 450 toward conductive element 432. Signal interface connection 450 is also coupled to one end of conductive element 455. Conductive element 455 is positioned adjacent to and parallel to conductive element 410 and extends toward conductive element 414. Signal interface connection 450 is also coupled to conductive element 460 which is positioned adjacent to and parallel to conductive element 440. An electrical wire 470 is coupled, at one end, to the end of conductive element 460 nearest to signal interface connection 450. Electrical wire 470 extends outward in a direction perpendicular to conductive element 460 and away from conductive element 440. An electrical wire 480 is coupled to the end of conductive element 460 farthest from the signal interface connection 450. Electrical wire 480 extends outward in a direction adjacent to and parallel to conductive element 470.

A center conductor of a coaxial cable 490 is coupled to signal interface connection 420 while the conductive shield of coaxial cable 490 is coupled to signal interface connection 450. The coaxial cable 490 may be any one of several possible industry standard cables including, but not limited to, radio guide (RG) type 174, RG type 178, RG type 214, and the like. The coupling mechanism between co-axial cable 490 and signal interface connections 420 and 450 may be a permanent or semi-permanent coupling, such as an electrical solder connection. In some embodiments, the coupling mechanism may include one or more plug connectors attached to the coaxial cable 490 that mechanically couple to compatible socket connectors used for signal interface connections 420 and 450. The plug and socket connectors may be one of several industry standard connectors including, but not limited to, miniature high frequency (MHF) type, subminiature version A (SMA) type, and the like. It is worth noting that the coupling between conductive element 460 and electrical wires 470 and 480 may also include plug and socket signal interface connections (not shown) that facilitate a similar coupling mechanism as described above.

Conductive elements 410, 412, 414, 430, 432, 440, 455, and 460, along with signal interface connections 420 and 450 are formed on one surface of printed circuit board 405 as part of an antenna structure. Printed circuit board 405 is made from a non-conductive rigid laminate material that is typically designed for use with radio frequency (RF) circuitry. The laminate material typically may have a thickness between 0.020 inches and 0.064 inches. In the present embodiment, printed circuit board 405 uses a single layer printed circuit board, having conductive material on only one surface. In other embodiments, double sided printed circuit boards, having conductive material on both surfaces, and multi-layer printed circuit boards, having conductive material on laminated inner layers, may be used. In some embodiments, the above elements are formed by etching away a portion of a conductive layer (e.g., copper) that is attached to the surface of the laminate material until only the pattern of the above elements remains. In other embodiments, conductive material may be added to the surface of the laminate material to form a conductive layer in the pattern of the above elements. Additionally, holes or slots may be cut through the conductive layer and/or the laminate material to facilitate the coupling mechanisms described above or to adjust operational characteristics of antenna assembly 400.

Electrical wires 470 and 480 may use single conductor wires made from either solid or stranded conductive material, such as copper, or copper alloy. The wire gauge for electrical wires 470 and 480 may be determined based on the frequency range or ranges of operation and may range from 28 gauge to 15 gauge for the wire. One or both of the electrical wires may be insulated with an industry standard nonconductive plastic coating in order to prevent undesired connection to other conductive surfaces. In one embodiment, electrical wires 470 and 480 may use 24 gauge insulated wire. In some embodiments, electrical wires 470 and 480 may be connected to conductive element 460 using a solder connection. In other embodiments, electrical wires 470 and 480 may be connected using a plug and socket connection as described above. In some embodiments, electrical wires 470 and 480 may use multi-conductor wires, such as coaxial cable similar to that described above. In some instances, each of the conductors in the multi-conductor wires may be connected together at the connection to conductive element 460.

The spatial distance and positional relationship between electrical wires 470 and 480 is similar to conductive elements 370 and 380 described above. Electrical wires 470 and 480 are used as part of forming an effective ground plane surface that acts as a ground extension, improving the performance of over at least one of the frequency ranges of operation for antenna assembly 400. The use of electrical wires 470 and 480 offer the additional advantages. Electrical wires 470 and 480 may be configured for easier attachment and detachment, such as through a plug and connector mechanism. Electrical wires 470 and 480 may also allow for more flexible positioning and placement due to ease of shaping and bending of electrical wires as well as allowing positioning and placement near other conductive surfaces or elements due to the presence of the insulation over the conductors.

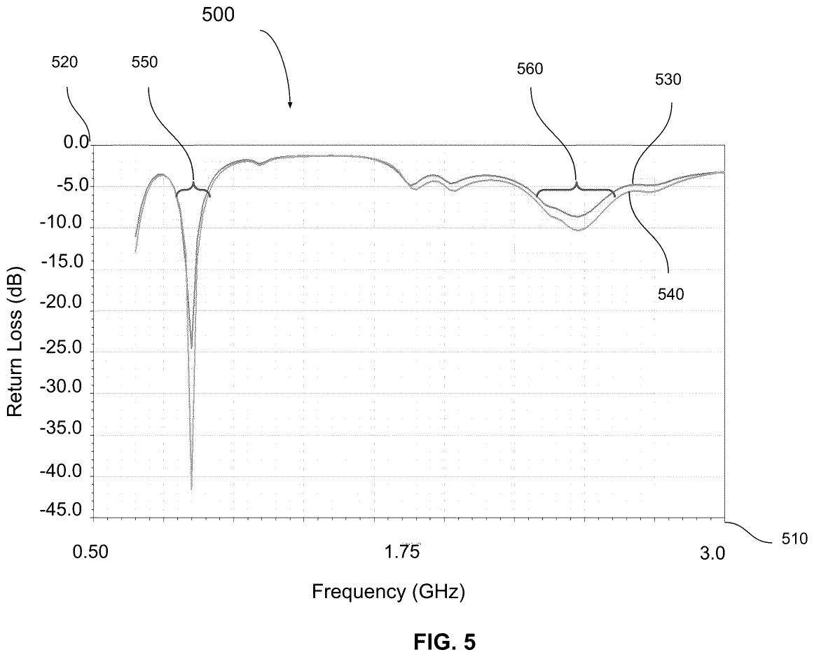

Turning now to FIG. 5, a graph 500 illustrating the electrical characteristics of an antenna assembly, in accordance with aspects of the present disclosure. Graph 500 represents the design simulation results for the scalar value of return loss, displayed over a frequency range, for antenna assembly 400 described in FIG. 4 and the antenna assembly similar to that described in FIG. 1. The return loss values are measured at the coaxial cable connected to antenna assembly (i.e., coaxial cable 490 along with coaxial cable 190). The ground plane extension elements of each antenna (i.e., electrical wires 470 and 480 and conductive foil sheet 170) are connected to the ground reference used for the coaxial cable.

Graph 500 includes an x-axis 510 displaying frequency in gigahertz (GHz). Graph 500 also includes a y-axis 520 displaying return loss in decibels (dB). Line 530 displays the value of return loss versus frequency for antenna assembly 400 described in FIG. 4. Line 530 displays the value of return loss versus frequency for an antenna similar to antenna 100 described in FIG. 1. Indicator 550 and indicator 560 highlights the two frequency ranges of operation and shows that return loss values for line 530 are similar to the return loss values for line 540 within the two frequency ranges of operation.

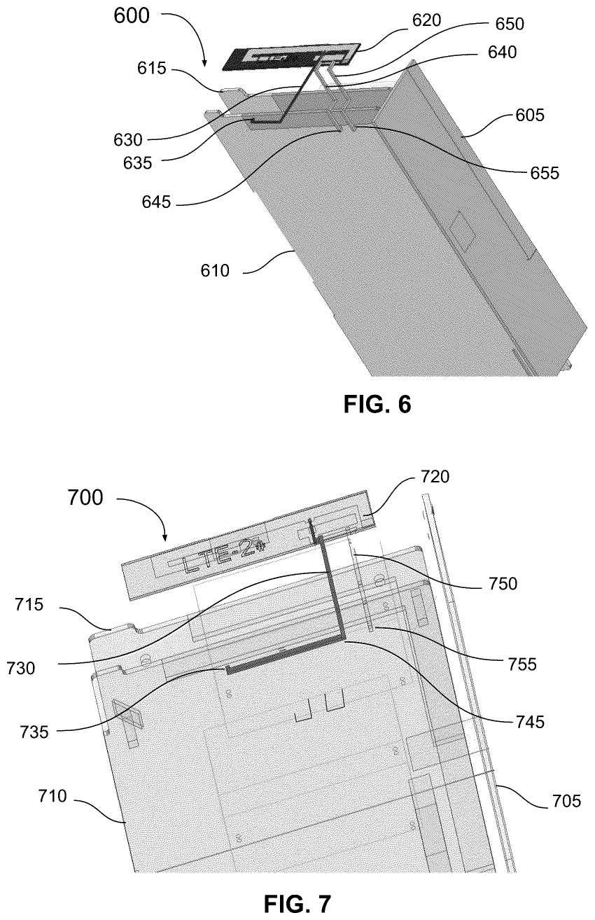

Turning now to FIG. 6, a perspective view of an exemplary electronic assembly 600 having an integrated antenna assembly according to aspects of the present disclosure is shown. Electronic assembly 600 may be included as part of an apparatus used for wireless communications, such as communication device 100 described in FIG. 1. Electronic assembly 600 is configured to be completely contained within the enclosure of the apparatus. However, in some embodiments, some portion of electronic assembly 600, including some or all of the antenna assembly, may be located external to the enclosure. Electronic assembly 600 includes an integrated antenna that operates in a manner similar to antenna assembly 400 described in FIG. 4. Electronic assembly 600 may alternatively or additionally include an integrated antenna that operates in a manner similar to antenna assembly 300 described in FIG. 3.

Electronic assembly 600 includes metal frame 605 that mechanically secures printed circuit boards 610 and 615. Printed circuit board 610 includes circuit components and conductive interconnecting traces that are configured to operate as a communication circuit, such as communication circuit 210 in FIG. 1. Printed circuit board 615 may have components and interconnecting traces that are configured to operate as other circuitry needed for the operation of the electronic assembly or apparatus, such as processors, memory, and the like.

Electronic assembly 600 also includes an antenna structure 620. Although antenna structure 620 is shown mechanically separate from electronic assembly 600, antenna structure 620 may be mounted to an additional portion of a frame or mounted to one of the printed circuit boards 610, 615 using a bracketing assembly. The mounting detail is not shown in order to more clearly illustrate the structure and arrangement of the antenna structure 620 within electronic assembly 600. antenna structure 620 is configured to include a pattern of conductive elements formed out of copper foil adhered to a printed circuit board laminate through an etching process. The pattern of conductive elements forms a portion of a dual-band antenna similar to those described in FIG. 3 and FIG. 4. For example, the pattern of conductive elements may be similar to the conductive elements 310 to 360 described for the dual-band antenna in FIG. 3. Alternatively, the pattern of conductive element may be similar to the conductive elements 410 to 460 described for the dual-band meander-line antenna in FIG. 4.

A coaxial cable 630 couples a communication signal between antenna structure 620 and circuit board 610. The center conductor and shield of one end of coaxial cable 630 are connected to antenna structure 620 in a manner similar to that described in either FIG. 3 or FIG. 4 above. The center conductor and shield of the other end coaxial cable 630 are connected to circuit board 610 through interface connection 635. Interface connection 635 may include one or more socket connectors that are coupled to conductive traces for interfacing the signal and ground to circuitry on circuit board 610. The one or more socket connections are compatible with corresponding plug connectors attached to coaxial cable 630 as described above. Interface connection 635 may alternatively include one or more soldering terminals that are further coupled to the signal and ground conductive traces on circuit board 610. At least one of the conductive traces is coupled to the signal input and/or signal output of one or more electrical components that operate as part of the communication circuit for receiving and/or transmitting the communication signal (e.g., communication circuit 210 in FIG. 1). The remaining conductive traces are coupled to the signal ground on circuit board 610 that is associated with the electrical component(s).

Electrical wires 640 and 650 are also coupled between antenna structure 620 and circuit board 610 and form the remaining portion of the multi-band antenna described in FIG. 3 or FIG. 4 that is not included as part of antenna structure 620. Electrical wires 640 and 650 may be permanently or semi-permanently attached to circuit board 610 through interface connections 645 and 655. One or both of the interface connections 645 and 655 may each include a socket connector that is coupled to conductive traces for the ground associated with the electrical component(s) that operate as part of the communication circuit on circuit board 610 as described above. The one or more socket connections are compatible with corresponding plug connectors attached to electrical wires 640 and 650 as described above. One or both of the interface connections 645 and 655 may alternatively include one or more soldering terminals that are further coupled to the conductive traces for the ground associated with the electrical component(s).

It is worth noting that as shown, electrical wires 640 and 650 have a particular orientation and position and further follow a particular path coupling antenna structure 620 to circuit board 610 while remaining adjacent and parallel to each other in a manner as described above. In some embodiments, it may be advantageous to replicate the orientation, position and path that would be utilized for any similar antenna (e.g., an antenna assembly that included a conductive foil sheet) as part of previous design and analysis work for the electronic assembly 600. However, different orientations, positions, and/or paths may be used for coupling electrical wires 640 and 650 while still utilizing the principles of the present disclosure. Further, the position, orientation, and/or path followed by coaxial cable 630 while coupling antenna structure 620 to circuit board 610 may not have any significant influence on the operation of the embodiment represented by electronic assembly 600.

Turning now to FIG. 7, a perspective view of another exemplary electronic assembly 700 having an integrated antenna assembly according to aspects of the present disclosure is shown. Electronic assembly 700 may be included as part of an apparatus used for wireless communications, such as communication device 100 described in FIG. 1. Electronic assembly 700 is configured to be completely contained within the enclosure of the apparatus. However, in some embodiments, some portion of electronic assembly 700, including some or all of the antenna assembly, may be located external to the enclosure. Electronic assembly 700 includes an integrated antenna that operates in a manner similar to antenna assembly 400 described in FIG. 4. Electronic assembly 600 may alternatively or additionally include an integrated antenna that operates in a manner similar to antenna assembly 300 described in FIG. 3. Except as described below, the structure, orientation, and operation of elements 705, 710, 715, 720, 730, 735, and 755 are similar to the operation of elements 605, 610, 615, 620, 630, 635, and 655 described in FIG. 6 above and will not be described in further detail here.

In electronic assembly 700, the coaxial cable 730 not only used to couple the communication signal between antenna structure 720 and circuit board 710 but also to replace the electrical wire that is positioned adjacent to and parallel to electrical wire 750 (e.g., electrical wire 640 described in FIG. 6). Coaxial cable 730 is connected at one end to interface connection 735 on circuit board 710 in a manner similar to that described above. Coaxial cable 730 is routed to interface connection 745. The outer conductive shield portion of coaxial cable 730 is connected to interface connection 745 and coaxial cable 730 is further positioned adjacent to and parallel to electrical wire 750 following the same path as electrical wire 750 to antenna structure 720. The other end of coaxial cable 730 is connected to antenna structure 720 in a manner similar to that described in FIG. 3 or FIG. 4 above. The outer conductive shield of coaxial cable 730 may also be connected to a conductive element on antenna assembly as described in FIG. 6. As a result, a portion of co-axial cable assembly 730 may be used in place of one of the two electrical wires or conductive elements used to form the ground plane extension as described above.

According to the present disclosure, an antenna assembly is described that includes an antenna structure configured to operate in a first frequency range and a second frequency range that is different from the first frequency range. The antenna assembly further includes a first conductive element coupled at one end to a first end of a conductive ground element on the antenna structure, the first conductive element extending outward in a direction perpendicular to the ground element and away from the antenna structure and a second conductive element coupled at one end to a second end of the ground element on the antenna structure, the second conductive element extending outward in a direction perpendicular to the conductive ground element away from the antenna structure, the second conductive element extending parallel to the first conductive element. The first conductive element and the second conductive element form a ground plane extension for the antenna structure that improves the performance of the antenna assembly in at least one of the first frequency range and the second frequency range of operation.

In some embodiments, the first conductive element is coupled at a second end to a ground element on a communication circuit assembly and the second conductive element is coupled at a second end to the ground element on the communication circuit assembly.

In some embodiments, the antenna structure is coupled to the communication circuit assembly using a coaxial cable assembly having a center conductor and an outer conductive ground shield.

In some embodiments, one of the first conductive element and the second conductive element is at least a portion of the outer conductive ground shield of the coaxial cable assembly.

In some embodiments, the antenna structure includes a first driven antenna element coupled at one end to a signal connection interface, the first driven antenna element extending outward in length from the signal connection interface, the first driven antenna element configured to at least one of transmit and receive a communication signal wirelessly in the first frequency range of operation and a second driven antenna element coupled at one end to the signal connection interface, the second driven antenna element extending outward in a direction opposite the direction of the first driven antenna element, the second driven antenna element configured to at least one of transmit and receive the communication signal wirelessly in the second frequency range of operation. The signal connection interface is further coupled to the center conductor of the coaxial cable assembly.

According to the present disclosure an apparatus is described that includes a circuit capable of at least one of processing a communication signal received wirelessly from a network and processing a communication signal for transmission wirelessly to the network and an antenna assembly coupled to the circuit. The antenna assembly includes an antenna structure configured to operate in a first frequency range and a second frequency range that is different from the first frequency range. The antenna assembly further includes a first conductive element coupled at one end to a first end of a conductive ground element on the antenna structure, the first conductive element extending outward in a direction perpendicular to the ground element and away from the antenna structure and a second conductive element coupled at one end to a second end of the ground element on the antenna structure, the second conductive element extending outward in a direction perpendicular to the conductive ground element away from the antenna structure, the second conductive element extending parallel to the first conductive element. The first conductive element and the second conductive element form a ground plane extension for the antenna structure that improves the performance of the antenna assembly in at least one of the first frequency range and the second frequency range of operation.

In some embodiments, the circuit is included as part of a communication circuit assembly and the first conductive element is coupled at a second end to a ground element for the circuit, and wherein the second conductive element is coupled at a second end to the ground element for the circuit.

In some embodiments, the antenna structure is coupled to the circuit using a coaxial cable assembly having a center conductor and an outer conductive ground shield.

In some embodiments, one of the first conductive element and the second conductive element is at least a portion of the outer conductive ground shield of the coaxial cable assembly.

In some embodiments, the antenna structure includes a first driven antenna element coupled at one end to a signal connection interface, the first driven antenna element extending outward in length from the signal connection interface, the first driven antenna element configured to at least one of transmit and receive the communication signal over the network in the first frequency range of operation and a second driven antenna element coupled at one end to the signal connection interface, the second driven antenna element extending outward in a direction opposite the direction of the first driven antenna element, the second driven antenna element configured to at least one of transmit and receive the communication signal over the network in the second frequency range of operation. The signal connection interface is coupled to the center conductor of the coaxial cable assembly.

In some embodiments, the ground element on the antenna structure has a length equal to a distance between the first conductive element and the second conductive element.

In some embodiments, a distance between the first conductive element and the second conductive element is greater than 0.5 inches.

In some embodiments, at least one of the first conductive element and the second conductive element is an electrical wire.

In some embodiments, the antenna assembly is a dual-band antenna.

In some embodiments, the first frequency range of operation is 700 MHz to 800 MHz and the second frequency range of operation is 2500 MHz to 2700 MHz.

It is to be appreciated that, except where explicitly indicated in the description above, the various features shown and described are interchangeable, that is, a feature shown in one embodiment may be incorporated into another embodiment.

Although embodiments which incorporate the teachings of the present disclosure have been shown and described in detail herein, those skilled in the art can readily devise many other varied embodiments that still incorporate these teachings. Having described preferred embodiments of an antenna assembly for use in a communication device, it is noted that modifications and variations can be made by persons skilled in the art in light of the above teachings. It is therefore to be understood that changes may be made in the particular embodiments of the disclosure which are within the scope of the disclosure as outlined by the appended claims.

1. An antenna assembly comprising:
an antenna structure configured to operate in a first frequency range and a second frequency range that is different from the first frequency range;
a first conductive element coupled at one end to a first end to a conductive ground element on the antenna structure, the first conductive element extending outward in a direction perpendicular to the ground element and away from the antenna structure; and
a second conductive element coupled at one end to a second end of the ground element on the antenna structure, the second conductive element extending outward in a direction perpendicular to the conductive ground element away from the antenna structure, the second conductive element extending parallel to the first conductive element;
wherein the first conductive element and the second conductive element form a ground plane extension for the antenna structure that improves the performance of the antenna assembly in at least one of the first frequency range and the second frequency range of operation.

2. The antenna assembly of claim 1, wherein the ground element on the antenna structure has a length equal to a distance between the first conductive element and the second conductive element.

3. The antenna assembly of claim 1, wherein a distance between the first conductive element and the second conductive element is greater than 0.5 inches.

4. The antenna assembly of claim 1, wherein the first conductive element is coupled at a second end to a ground element on a communication circuit assembly, and wherein the second conductive element is coupled at a second end to the ground element on the communication circuit assembly.

5. The antenna assembly of claim 4, wherein the antenna structure is coupled to the communication circuit assembly using a coaxial cable assembly having a center conductor and an outer conductive ground shield.

6. The antenna assembly of claim 5, wherein one of the first conductive element and the second conductive element is at least a portion of the outer conductive ground shield of the coaxial cable assembly.

7. The antenna assembly of claim 1, wherein at least one of the first conductive element and the second conductive element is an electrical wire.

8. The antenna assembly of claim 1, wherein the antenna assembly is a dual-band antenna.

9. The antenna assembly of claim 1, wherein the first frequency range of operation is 700 Megahertz (MHz) to 800 MHz and the second frequency range of operation is 2500 MHz to 2700 MHz.

10. The antenna assembly of claim 1, wherein the antenna structure includes:
a first driven antenna element coupled at one end to a signal connection interface, the first driven antenna element extending outward in length from the signal connection interface, the first driven antenna element configured to at least one of transmit and receive a communication signal wirelessly in the first frequency range of operation; and
a second driven antenna element coupled at one end to the signal connection interface, the second driven antenna element extending outward in a direction opposite the direction of the first driven antenna element, the second driven antenna element configured to at least one of transmit and receive the communication signal wirelessly in the second frequency range of operation;
wherein the signal connection interface is coupled to the center conductor of the coaxial cable assembly.

11. An apparatus comprising:
a circuit capable of at least one of processing a communication signal received wirelessly from a network and processing a communication signal for transmission wirelessly to the network; and
an antenna assembly coupled to the circuit, the antenna assembly comprising:
an antenna structure configured to operate in a first frequency range and a second frequency range that is different from the first frequency range;
a first conductive element coupled at one end to a first end to a conductive ground element on the antenna structure, the first conductive element extending outward in a direction perpendicular to the ground element and away from the antenna structure; and
a second conductive element coupled at one end to a second end of the ground element on the antenna structure, the second conductive element extending outward in a direction perpendicular to the conductive ground element away from the antenna structure, the second conductive element extending parallel to the first conductive element;
wherein the first conductive element and the second conductive element form a ground plane extension for the antenna structure that improves the performance of the antenna assembly in at least one of the first frequency range and the second frequency range of operation.

12. The apparatus of claim 11, wherein the ground element on the antenna structure has a length equal to a distance between the first conductive element and the second conductive element.

13. The apparatus of claim 11, wherein a distance between the first conductive element and the second conductive element is greater than 0.5 inches.

14. The apparatus of claim 11, wherein the circuit is included as part of a communication circuit assembly, and wherein the first conductive element is coupled at a second end to a ground element for the circuit, and wherein the second conductive element is coupled at a second end to the ground element for the circuit.

15. The apparatus of claim 14, wherein the antenna structure is coupled to the circuit using a coaxial cable assembly having a center conductor and an outer conductive ground shield.

16. The apparatus of claim 15, wherein one of the first conductive element and the second conductive element is at least a portion of the outer conductive ground shield of the coaxial cable assembly.

17. The apparatus of claim 11, wherein at least one of the first conductive element and the second conductive element is an electrical wire.

18. The apparatus of claim 11, wherein the antenna assembly is a dual-band antenna.

19. The apparatus of claim 11, wherein the first frequency range of operation is 700 MHz to 800 MHz and the second frequency range of operation is 2500 MHz to 2700 MHz.

20. The apparatus of claim 11, wherein the antenna structure includes:
a first driven antenna element coupled at one end to a signal connection interface, the first driven antenna element extending outward in length from the signal connection interface, the first driven antenna element configured to at least one of transmit and receive the communication signal over the network in the first frequency range of operation; and
a second driven antenna element coupled at one end to the signal connection interface, the second driven antenna element extending outward in a direction opposite the direction of the first conductive element, the second driven antenna element configured to at least one of transmit and receive the communication signal over the network in the second frequency range of operation;
wherein the signal connection interface is coupled to the center conductor of the coaxial cable assembly.
